(19) United States
(12) Patent Application Publication
(10) Pub. No.: US 2011/0302100 A1
(43) Pub. Date: Dec. 8, 2011

(54) METHOD AND SYSTEM FOR IDENTIFICATION OF TALENT ON THE BASIS OF A TARGET CANDIDATE PROFILE

(75) Inventor: Paaul Randhip Selvakummar, Streamwood, IL (US)

(73) Assignee: FORTE HCM INC., Hoffman Estates, IL (US)

(21) Appl. No.: 13/111,729

(22) Filed: May 19, 2011

Related U.S. Application Data
(60) Provisional application No. 61/352,131, filed on Jun. 7, 2010.

(51) Int. Cl. G06Q 10/00

(52) U.S. Cl. 705/321

(57) ABSTRACT

Embodiments of the invention relate to a system, method and apparatus for identifying at least one candidate from a plurality of candidates based on at least one target candidate profile associated with the at least one target candidate. The method includes identifying at least one candidate from a plurality of candidates based on at least one target candidate profile associated with the at least one target candidate. The method further includes constructing profile images for candidates; representing the at least one candidate profile in a multi-dimensional characteristic space; executing a search of a plurality of candidate profiles associated with the plurality of candidates; and identifying the at least one candidate having the at least one candidate profile almost identical to the at least one target candidate profile.

### CLAIM FOR PRIORITY

This application is related to, and claims priority from, U.S. Provisional Application No. 61/352,131 filed Jun. 7, 2010 titled “Method and System for Identification of Talent on the Basis of a Target Candidate Profile” the complete subject matter of which is incorporated herein by reference in its entity.

### FIELD OF THE INVENTION

The present invention relates generally to computing systems and data processing. More specifically, it relates to a computer system and method for identification of candidates with profiles similar to that of a target candidate profile.

### BACKGROUND OF THE INVENTION

The term Human Capital refers to the stock of talent and ability embodied within the workforce population of an organization. More simply stated, it refers to the people that make an organization. While companies have always recognized the importance of human capital to their economic growth, the accelerated shift to knowledge-based economy in recent times has further accentuated its importance. Thus, the ability to identify and hire the right talent in the shortest amount of time possible coupled with the ability to retain such hired talent is vital to an organization's ability to stay on top of the global economy. This has direct bearing on the talent acquisition mechanisms available to organizations today to achieve these goals.

Typically, when an organization needs to hire a new employee, either on a permanent basis or contract basis, often times, the hiring manager in collaboration with the human resources manager, drafts a position profile that describes the characteristics expected of the new employee. The position profile typically consists of a detailed description of the role, the skills, knowledge, experience and education required to perform in the role, the team profile, cultural aspects, duration of the position, and commercial aspects associated with the position. This then is published to either an in-house corporate recruitment team and/or a recruitment agency for fulfillment.

Often times, the group in-charge of fulfilling the job opening advertises the position on print or electronic media and receives resumes from prospective candidates in response to the advertisement, or performs searches for prospective candidates on job boards by specifying a set of keywords representing the skills/qualifications expected of the candidate. The resumes are then manually reviewed to assess the qualifications of the candidate, and those candidates whose resumes appear to reflect the qualifications called for in the position are then invited for an interview.

There exist several situations where a recruiting agent needs to identify candidates with profiles that are almost identical to that of a target candidate. Some of these situations include identifying a replacement for an exiting employee, identifying a replacement for a no-show candidate that was screened and selected, and identifying additional candidates with profiles similar to that of a candidate that has been screened and selected.

Often times, the recruiting agent either executes a new search for candidates using the methods outlined above, or searches through the pool of candidates that were pre-screened and shortlisted early on during the initial hiring process, in order to identify such candidates. This process has several problems associated with it. The most obvious of the problems is the amount of time consumed in reviewing the qualifications of the large number of candidates while executing a new search to identify similar profiles. Often times, even comprehensive keywords specification most times result in matches numbering in the thousands. In addition to being a daunting task, the limited amount of time available to recruiting agents to fulfill positions more often than not causes them to oversee qualified resumes and in the process lose out on the talented candidates that they belong to. The second drawback associated with this process is that, often times, not all qualities of a pre-selected candidate that is embodied within the candidate's profile are adequately captured within the original position profile. Considering that the selected candidate has likely been put through several levels and forms of assessments, it is reasonable to assume that the selected candidate's profile consists of desirable elements that influenced his selection for the position, in spite of those elements not being a part of the position profile. When new searches are therefore executed using only the position profile, it not only lends itself to loss of time resulting from the need to screen and assess candidates again, but also yields results that are not a holistic match to the target candidate profile.

As a result, it would be desirable to provide a talent acquisition system that is capable of identifying talent on the basis of an existing candidate profile, in addition to a position profile.

### SUMMARY OF THE INVENTION

Embodiments of the present invention relate to a computer system, method and apparatus for identifying candidates on the basis of an existing candidate profile. The system, method and apparatus comprises a talent cloning system that provides users engaged in the hiring/recruitment process a platform to identify candidates with profiles that are almost identical to that of a target candidate by executing searches on the basis of a target candidate profile, a process referred to as talent cloning in the rest of the description. The system, method and apparatus further comprises a multidimensional profile imaging approach to representing candidate information, where candidates with similar profiles are clustered together in a multidimensional characteristics space. The system, method and apparatus further comprises representation of candidates by means of graphical objects such as spheres in a two dimensional space where candidates with similar profiles are clustered together. The system, method and interface further comprise ability to integrate with an applicant tracking system to access and retrieve search criteria pertaining to a predefined position. The system, method and apparatus further comprises a user interface for search criteria specification, search results display, talent cloning execution, search summary display, candidate information and reports display, and resume and profile image display.

One embodiment relates to a method for identifying at least one candidate from a plurality of candidates based on at least one target candidate profile associated with the at least one target candidate. The method includes constructing profile images for candidates; representing the at least one candidate profile in a multi-dimensional characteristic space; executing a search of a plurality of candidate profiles associated with the plurality of candidates; and identifying the at least one candidate having the at least one candidate profile almost identical to the at least one target candidate profile.

One or more embodiments of the method relate to constructing the profile image of the at least one candidate using the candidate's resume and XML record; where the profile image is a multidimensional artifact that encapsulates a holistic representation of at least one of the at least one candidate's skills, the at least one candidate's experience and the at least one candidate's qualifications. In at least one embodiment, the profile image comprises at least one pre-defined competency vector. In further embodiments, the multidimensional profile space consists of at least one profile image, wherein the at least one profile image occupies a point in a multidimensional profile space; where each axis of the multidimensional profile space is characterized by a competency vector-vector parameter combination, wherein the total number of competency vector-vector parameter combinations is equal to a total number of dimensions.

In at least one embodiment, the method includes identifying the at least one candidate having the at least one candidate profile almost identical to that of at least one target candidate by determining distances between a plurality of candidate profile images and the at least one target candidate profile image in the multidimensional profile space, and may further include determining the at least one profile image of the plurality of profile images having a smallest distance with respect to the at least one target candidate profile image. Further, candidate profiles having similar profile images will be located in close proximity in the multidimensional profile space.

In at least one embodiment, the method further includes acquiring a resume and monitoring the arrival of new resume files into a candidate information system/resume repository by a multisource talent acquisition system and subsequent processing of the resume files. Embodiments may further include assigning varying weightage to different parameters of the target candidate's profile, and prioritizing one category of competency over another and one parameter over another. Embodiments may further include performing a contextual information search on candidate resumes, evaluating the context of occurrence of each search term on the candidate's resume in order to efficiently value real-world project experience, efficiently value recent project experiences, and identify and value possible certifications and specialist level skills. The candidates may be positioned on a gradient display based on the distance values with those with the shortest distance from the target candidate being placed closer towards the center, wherein the distance of a candidate object from the center of the display is a direct visual indicator of the level of match of the represented candidate with the target candidate.

At least one embodiment relates to a system for automatically identifying at least one candidate from a plurality of candidates based on at least one target candidate profile associated with the at least one target candidate. The system includes a memory for storing instructions and data, the data comprising a set of programs and a dataset having one or more data fields; and a processor executing the instructions and processing the data. The instructions include constructing profile images for candidates; representing the at least one candidate profile in a multi-dimensional characteristic space; executing a search of a plurality of candidate profiles associated with the plurality of candidates; and identifying the at least one candidate having the at least one candidate profile almost identical to the at least one target candidate profile.

One or more embodiments of the system include constructing the at least one candidate profile image using the candidate's resume and XML record, where the profile image is a multidimensional artifact that encapsulates a holistic representation of at least one of the at least one candidate's skills, the at least one candidate's experience and the at least one candidate's qualifications. Embodiments of this system may include a multidimensional profile space consisting of a plurality of profile images, wherein each of the profile images occupies a point in multidimensional profile space; wherein each axis of the multidimensional profile space is characterized by a competency vector-vector parameter combination, further wherein a total number of competency vector-vector parameter combinations being equal to a total number of dimensions. The system may include identifying the at least one candidate having the at least one candidate profile image almost identical to that of at least one target candidate by determining distances between a plurality of candidate profile images and the at least one target candidate profile image. The system may further include identifying the at least one candidate having the at least one candidate profile image almost identical to that of at least one target candidate by determining the at least one profile image of the plurality of profile images having a smallest distance with respect to the at least one target candidate profile image.

Yet another embodiment relates to an apparatus for automatically identifying at least one candidate from a plurality of candidates based on at least one candidate profile associated with the at least one candidate, the system including an applicant tracking system; a user interface; a talent cloning system communicating with at least one of the applicant tracking system and the user interface, and that executes instructions and processes data. The instructions include constructing profile images for candidates; representing the at least one candidate profile in a multi-dimensional characteristic space; executing a search of a plurality of candidate profiles associated with the plurality of candidates; and identifying the at least one candidate having the at least one candidate profile almost identical to the at least one target candidate profile.

Yet one or more embodiments of the apparatus may include a system constructing the at least one candidate profile image using the candidate's resume and XML record, where the profile image is a multidimensional artifact that encapsulates a holistic representation of at least one of the at least one candidate's skills, the at least one candidate's experience and the at least one candidate's qualifications. The apparatus may include a multidimensional profile space consisting of at least one profile image, wherein the at least one profile image occupies a point in a multidimensional profile space; identifying the at least one candidate having the at least one candidate profile almost identical to that of at least one target candidate by determining distances between a plurality of candidate profile images and the at least one target candidate profile image in the multidimensional profile space. In at least one embodiment of the system candidate profiles having similar profile images will be located in close proximity in the multidimensional profile space.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic representation of a system and method according to the present invention;

FIG. 2 is an illustration of an exemplary hardware arrangement for implementing the method and system of FIG. 1;

FIG. 3 is a schematic representation of a system and method according to the present invention;

FIG. 4 is a flow chart representing operation of elements of FIG. 1;

FIG. 5 is an exemplary web page for the method and system of FIG. 1;

FIG. 6 is an exemplary web page for the method and system of FIG. 1;

FIG. 7 is an exemplary web page for the method and system of FIG. 1;

FIG. 8 is a flow chart representing operation of elements of FIG. 1;

FIG. 9 illustrates an exemplary template for a candidate XML record;

FIG. 10a illustrates an exemplary profile image template;

FIG. 10b illustrates an exemplary profile image for a candidate;

FIG. 10c illustrates an exemplary profile image for a candidate;

FIG. 11a is an exemplary web page for the method and system of FIG. 1;

FIG. 11b is an exemplary web page for the method and system of FIG. 1;

FIG. 12 is an exemplary web page for the method and system of FIG. 1;

FIG. 13 is an exemplary web page for the method and system of FIG. 1;

FIG. 14 is an exemplary web page for the method and system of FIG. 1;

FIG. 15 is an exemplary web page for the method and system of FIG. 1;

Throughout the various figures, like reference numbers refer to like elements.

### DETAILED DESCRIPTION OF PRESENTLY PREFERRED EMBODIMENTS

In the description that follows, the subject matter of the method and system will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

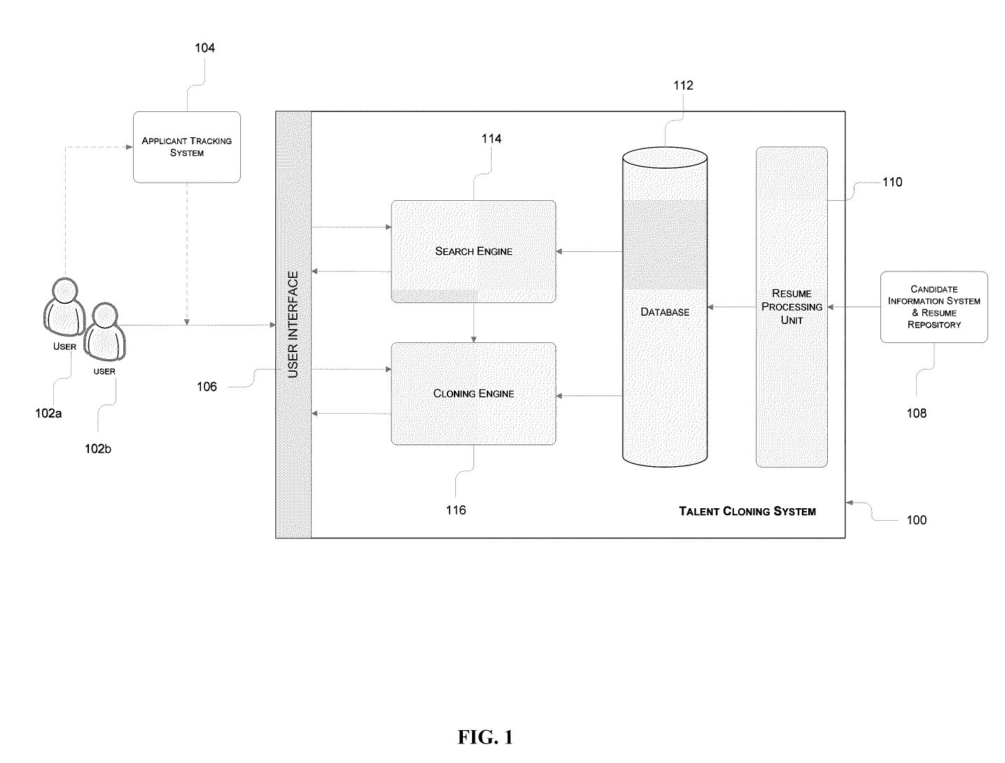

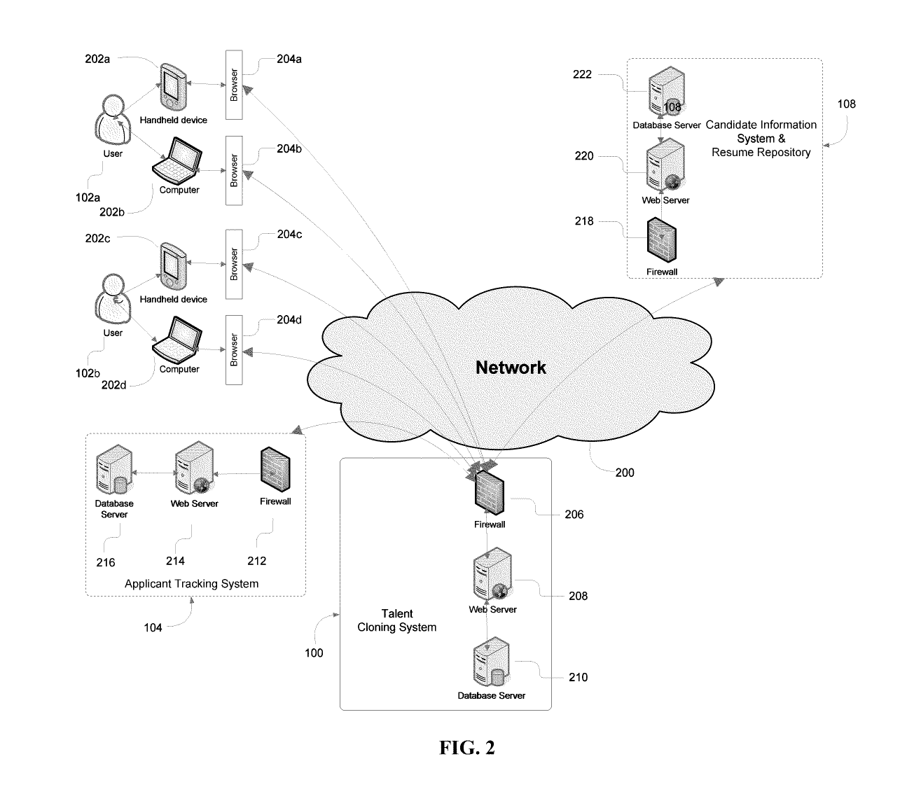

FIG. 1 illustrates a high-level overview of the method and system proposed in the present invention. The method and system of the present invention can be accomplished using a variety of hardware arrangements. FIG. 2 illustrates an exemplary hardware arrangement. The talent cloning system 100 is data connected with the applicant tracking system 104, and the candidate information system/resume repository 108. Applicant tracking system refers to a method and system used by hiring managers and recruiting agents to register positions and manage candidate applications for such positions. In one embodiment, the applicant tracking system enables users to identify candidates that are under consideration for a certain position and their statuses in the recruitment process by executing a search using parameters related to the position or the candidate. Such parameters may include the name of the position, client name, position number, candidate name etc.

An embodiment of the talent cloning system 100 is composed of a web server 208 and a database server 210, which communicate with the network 200 through a firewall 206. The web server 208 and database server 210 include a computer with a display, input/output devices, processor, memory and storage device. The computer uses any one of the commercially available operating systems such as Windows Server 2003, and runs a commercially available web server application such as Internet Information Services. The database server 210 includes any relational database such as SQL Server. The software programs that represent the disclosed methods reside in the storage device, and are executed by the processor.

The applicant tracking system 104, and candidate information system/resume repository 108 are each composed of a web server (214, 220) and database server (216, 222) that include a computer with a display, input/output devices, processor, memory and storage device and communicate with the network 200 through a firewall (212, 218). In one embodiment, one or more of the systems listed above share a common web server and data server. In an alternate embodiment, the systems are housed in separate web servers and data servers and communicate with each other through the network 200.

In one embodiment, user 102a communicates with the talent cloning system 100 through the network 200 by operating a computer 202b. The computer 202b is a personal computer or a laptop that includes a display, input/output devices, processor, memory and data storage, and runs any of the commercially available operating systems such as Windows XP, Windows Vista etc. In another embodiment, user 102a communicates with the talent cloning system 100 through the network 200 by operating a handheld device 202a such as a cell phone. The handheld device 202a and computer 202b invoke browsers 204a and 204b respectively for the user 102a to communicate with the talent cloning system 100. Examples of browser 204a and 204b include Internet Explorer, Mozilla Firefox, and Safari.

The hardware components shown in FIG. 2 and those described above are intended to be illustrative of the components that they represent and are therefore exemplary in nature and not intended to limit the scope of the present invention.

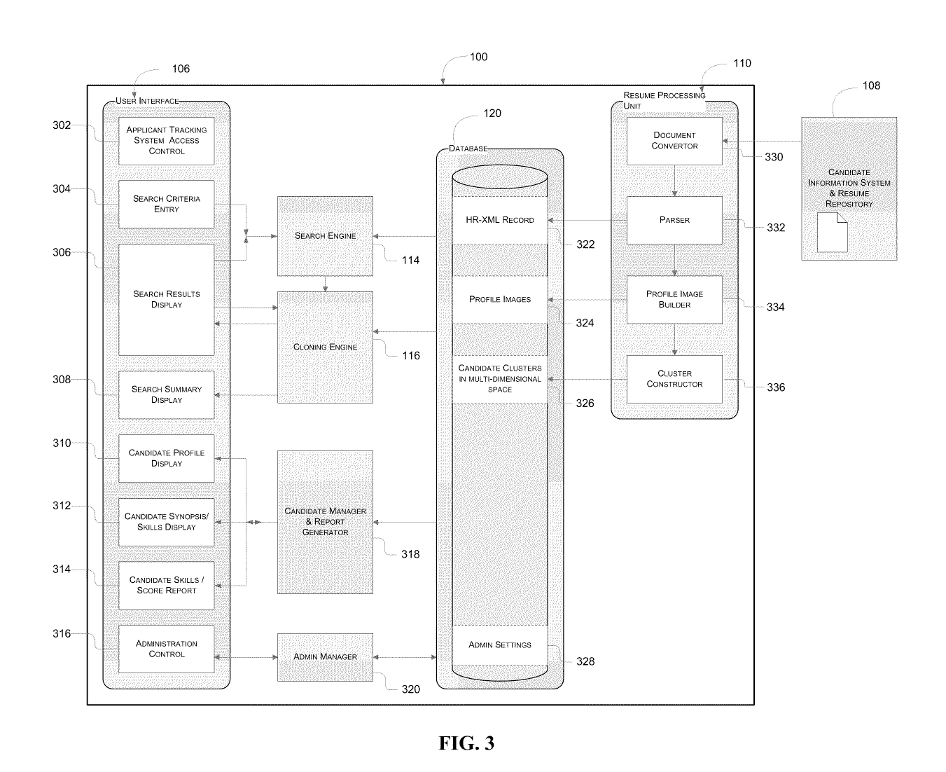

FIG. 3 illustrates a detailed view of the components included within the talent cloning system 100. User interface 106 refers to the set of components displayed on the web page pertaining to the talent cloning system 100 and is accessed by the user 102a on browser 204a. The components of the user interface 106 are represented by means of graphical elements on the web page and enable the user to interact with the software programs contained within the talent cloning system 100. The programs contained within the talent cloning system and the user interface can be implemented using a number of tools and languages suited for the purpose, some of which include .NET, Silverlight, Flex, etc. The components of the user interface 106 include position profile access control 302, search criteria entry field 304, search results display 306, search summary display 308, candidate profile display 310, candidate synopsis/skills display 312, candidate score/report display 314, and administration control 316. The talent cloning system 100 further includes a resume processing unit 110 that serves to access the candidate information system/resume repository 108 and process the retrieved resumes. The resume processing unit 110 further includes software programs such as document convertor 330, parser 332, profile image builder 334, and cluster constructor 336. Information processed by the programs contained within the resume processing unit 110 is stored in the database 112, also contained within the talent cloning system 100. Other programs contained within the talent cloning system 100 include search engine 114, cloning engine 116, candidate manager & report generator 318, and admin manager 320.

The description above only serves to illustrate the components contained within an embodiment of the talent cloning system 100. The methods represented by these components and their purposes will be more readily understood upon consideration of the attached diagrams and the rest of the detailed description contained within this document.

Method Overview

This section details an overview of the workings of the method and system proposed in the present invention. Subsequent sections will present embodiments of the method in finer detail. For purposes of illustration, search terms and skills pertaining to the field of Information Technology have been used. As those skilled in the art will understand, the method and system proposed in the present invention can be applied to a wide range of fields.

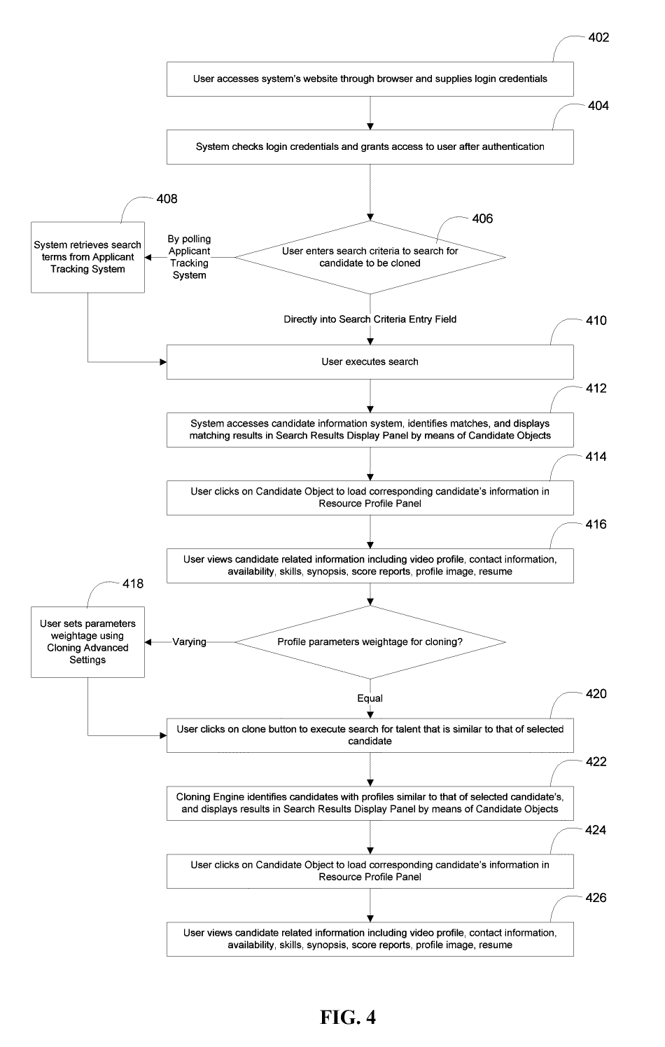

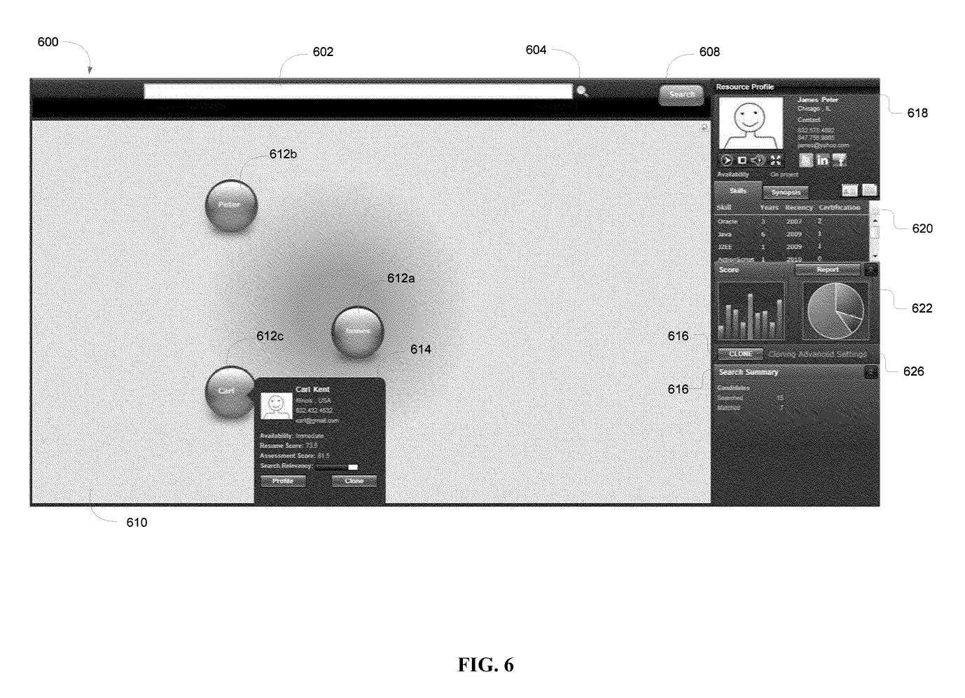

In FIG. 4, a flowchart representing the overview of the method is presented. FIG. 6 illustrates an exemplary screenshot of the webpage representing the talent cloning system 100. In one embodiment, referring to FIG. 4, in step 402, the user first accesses the talent cloning system 100 by entering the uniform resource locator (URL) corresponding to the web server 208 hosting the talent cloning system 100, in the browser.

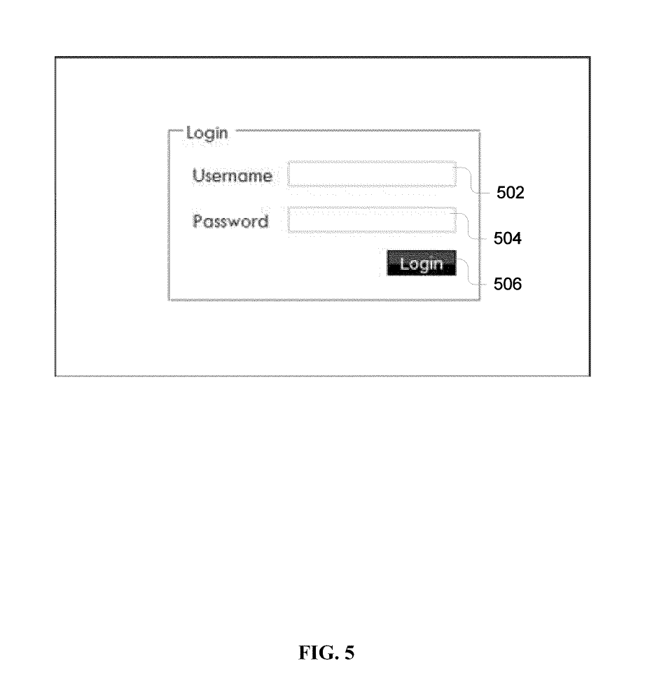

FIG. 5 illustrates an exemplary screenshot of the login webpage that is first presented to the user in his browser in response to his attempt to access the talent cloning system 100. The user enters his username and password in the fields 502 and 504 respectively, and clicks on the login button 506. Referring to FIG. 4, in step 404, the login information is transmitted back to the talent cloning system 100 through the network 200 for authentication. Once the user's login credentials have been authenticated, the user is presented with a webpage that represents the talent cloning system's screen. The webpage is as illustrated in FIG. 6, but is devoid of any information related to the search criteria, search results or candidate.

Referring to FIG. 4, in step 406, the user enters the search criteria in field 602 of the webpage 600 as illustrated in FIG. 6. In one embodiment, the user enters the name of the candidate to be cloned directly into field 602. In another embodiment, the user searches for the candidate to be cloned by polling the applicant tracking system 104. The user does so by clicking on the search glass icon 604, and then performing a search for the candidate to be cloned by using the position name, position number, client name etc. on a pop-up window that opens up as a result of clicking on the search glass icon 604. In the latter case, the talent cloning system 100 connects with the applicant tracking system 104, searches for positions that match the criteria specified by the user, and displays matching records in the pop-up window. The user then reviews the results displayed in the pop-up window, and clicks on the listing corresponding to the candidate of interest, leading to the candidate's name getting loaded in the search criteria entry field 602.

Referring to FIG. 4, in step 410, the user initiates the search by clicking on the search button 608. Referring to FIG. 4, in step 412, the talent cloning system 100 accesses the candidate information system/resume repository 108, identifies matches, and displays results in the search results display panel 610. Each candidate that is part of the search result is represented on the search results display panel 610 by means of a candidate object 612a. In one embodiment, spheres labeled with the names of candidates are used as candidate objects. In alternate embodiments, any graphical shape/element may be used as candidate objects.

When the user places the mouse pointer over a candidate object 612c, a profile snapshot window 614 pops open. The profile snapshot window 614 displays the candidate's name, location, contact details, availability, score, photo, and buttons for profile display and cloning. Information pertaining to the candidate displayed on the profile snapshot window 614 is procured by the talent cloning system 100 from the candidate information system/resume repository 108.

Returning to FIG. 4, in step 414, when the user clicks on a candidate object 612a, information pertaining to the candidate represented by the candidate object 612a gets displayed on the candidate profile display panel 618, candidate synopsis/skills display panel 620, and the candidate score/report display panel 622. The candidate profile display panel 618 includes information such as candidate's name, location, contact details, video profile, availability status, and links to external websites that carry more information about the candidate. The synopsis/skills display panel 620 includes a skills matrix and a professional summary about the candidate, as well as links/icons to display the candidate's resume and profile image. The score/report display panel 622 includes graphical charts that represent a summary of the candidate's skills as it pertains to the search criteria, and a button/link to open a more detailed report of the candidate's standing as it pertains to the search criteria.

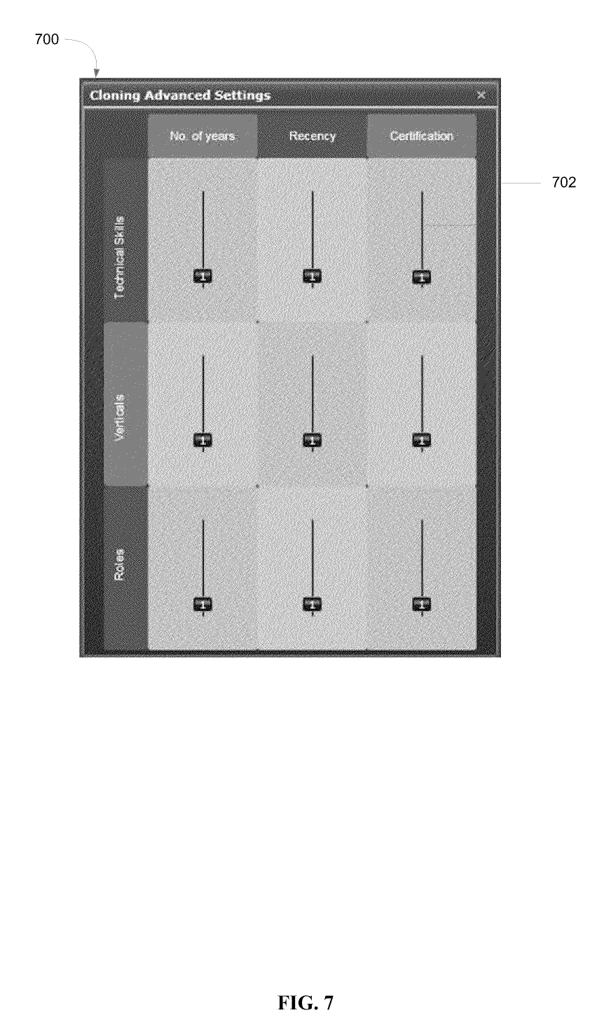

Referring to FIG. 4, in step 416, the user may now perform a wide variety of actions pertaining to the search. This includes and is not limited to viewing the candidate's video profile and accessing the candidate's external web pages from the candidate profile display panel 618, reviewing the candidate's skills, resume and profile image in the candidate synopsis/skills display panel 620. Referring to step 420, illustrated in FIG. 4, the user now proceeds to clone the candidate of interest by selecting a candidate object 612a representing a candidate and clicking on the clone button 624, or by clicking on the clone button in the profile snapshot window 614 that pops up while placing the mouse pointer over a candidate object. In another embodiment, referring to step 418 of FIG. 4, the user may choose to assign varying weightage to different parameters of the target candidate's profile. In order to do this, the user clicks on the cloning advanced settings button 626, causing a cloning advanced settings screen to be displayed by means of a pop-up window. FIG. 7 illustrates an example of a cloning advanced settings screen. By default, the cloning advanced settings screen 700 will exhibit equal weightage across all parameters. The user may however adjust the weightage using the slider controls 702, prior to executing the cloning action as illustrated in step 420 of FIG. 4. Referring to step 422, illustrated in FIG. 4, the cloning engine 116 identifies candidates with profiles similar to that of selected candidate's, and displays results in the search results display panel 610 by means of candidate objects 612a.

Referring to FIG. 4, in step 424, when the user clicks on a candidate object 612a, information pertaining to the candidate represented by the candidate object 612a gets displayed on the candidate profile display panel 618, candidate synopsis/skills display panel 620, and the candidate score/report display panel 622. The candidate profile display panel 618 includes information such as candidate's name, location, contact details, video profile, availability status, and links to external websites that carry more information about the candidate. The synopsis/skills display panel 620 includes a skills matrix and a professional summary about the candidate, as well as links/icons to display the candidate's resume and profile image. The score/report display panel 622 includes graphical charts that represent a summary of the candidate's skills as it pertains to the search criteria, and a button/link to open a more detailed report of the candidate's standing as it pertains to the search criteria.

Referring to FIG. 4, in step 426, the user may now perform a wide variety of actions. This includes and is not limited to viewing the candidate's video profile and accessing the candidate's external web pages from the candidate profile display panel 618, reviewing the candidate's skills, resume and profile image in the candidate synopsis/skills display panel 620.

Resume Processing

An embodiment of the talent cloning system involves resume processing as a sub-process. In one embodiment, resumes are acquired by recruiters from candidates and are uploaded into a candidate information system/resume repository 108. In an alternate embodiment, resumes are uploaded directly into the candidate information system/resume repository 108 by candidates. In addition to the resumes, the candidate information system may also store other information related to the candidate including but not limited to the candidate's current location and address, contact details, photo and/or video profile, current availability, details of work currently engaged in, and uniform record locators to web pages that carry information about the candidate.

In one embodiment, the candidate information system/resume repository is integrated within the same platform as that of the talent cloning system 100. In an alternate embodiment, the candidate information system/resume repository is external and communicates with the talent cloning system 100 over data network 200.

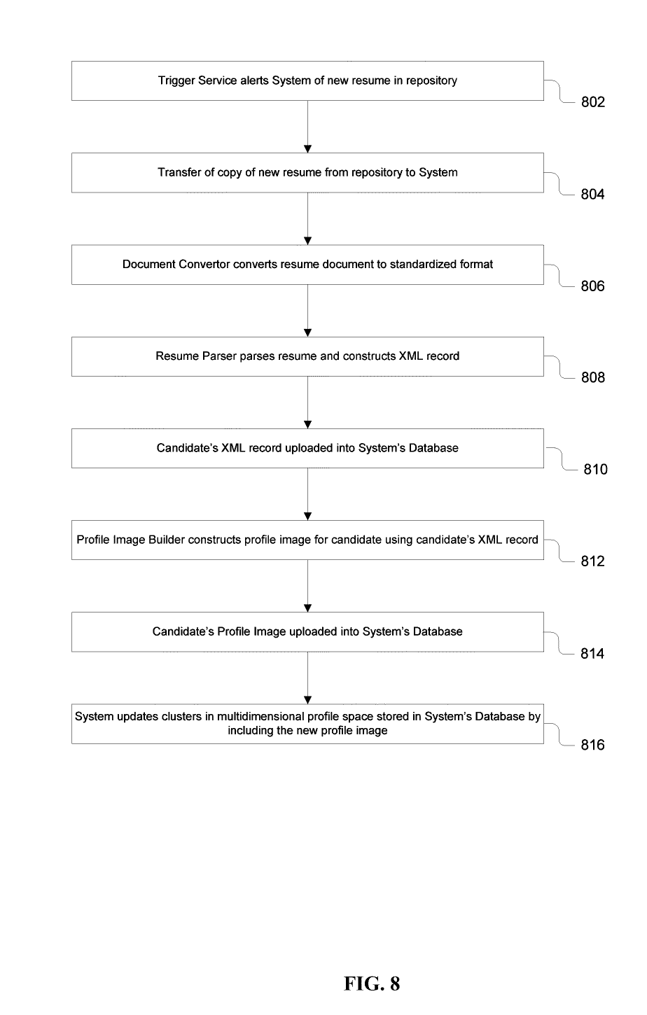

FIG. 8 is a flowchart that illustrates the method of acquisition of a resume by the talent cloning system and the subsequent processing of it. In step 802, illustrated in FIG. 8, a trigger service creates an alert whenever a new resume gets uploaded into the candidate information system/resume repository 108. The trigger service is a software program that keeps monitoring the arrival of new resume files into the candidate information system/resume repository 108, and generates a signal/message on realization of a new resume file being uploaded.

In step 804, illustrated in FIG. 8, following the alert by the trigger service, a copy of the newly uploaded resume is transferred from the candidate information system/resume repository 108 to the talent cloning system 100 using the file transfer protocol over the network 200. In one embodiment, this transfer happens immediately on receipt of the alert about the new resume file. In an alternate embodiment, a batch processing software program runs during pre-specified intervals, such as once a day, and transfers files that have been uploaded since the last transfer.

In step 806, illustrated in FIG. 8, the document convertor 330 software program, illustrated in FIG. 3, converts the transferred resume document to a standardized format. Since a variety of document formats, such as Microsoft Word and Adobe Portable Document Format (PDF), exist for candidates to publish their resumes in, the document convertor 330 enables conversion of the content contained within such documents to a standardized text format in order to facilitate further processing.

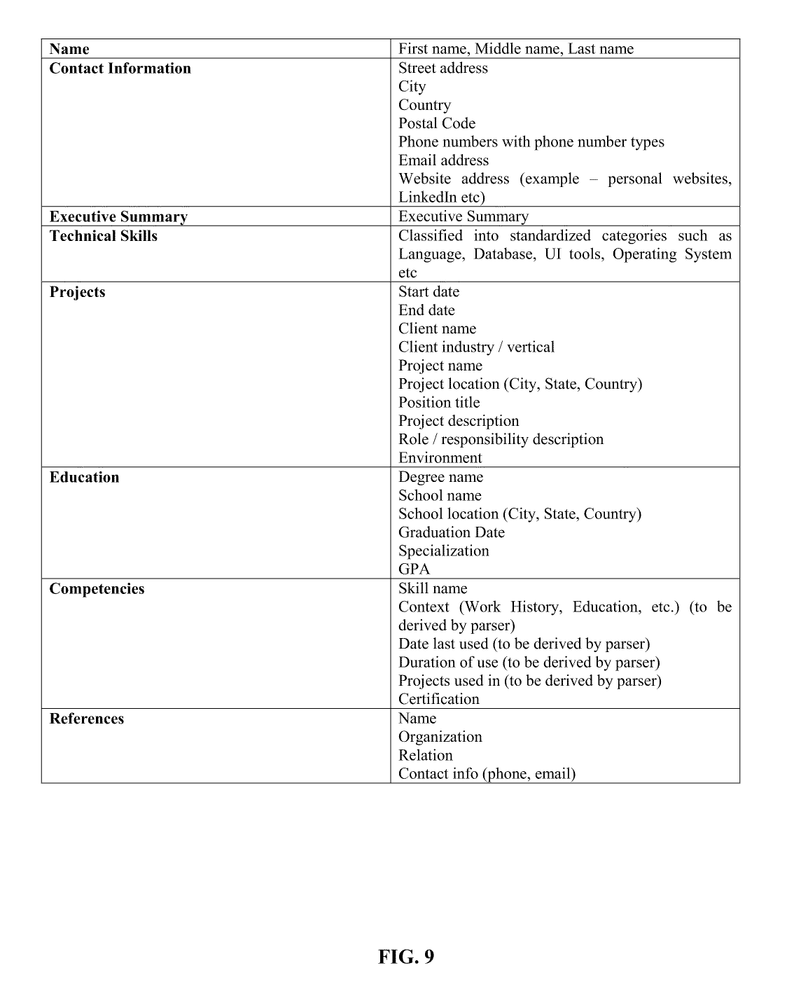

In step 808, illustrated in FIG. 8, the standardized text document representing the resume is parsed by a parser software program 332 and an Extensible Markup Language (XML) record for the candidate is constructed based on the HR-XML resume schema. HR-XML is a library of XML schemas developed by the HR-XML consortium to support a variety of business processes related to human resource management. In one embodiment, the XML record of the candidate includes elements such as name, contact information, executive summary, technical skills matrix, projects, education, competencies and references. FIG. 9 illustrates an exemplary template for the XML record. In alternate embodiments, the XML record template may be customized based on the context of use. The parser 332 is a software program that scans and analyzes the textual content of the resume document, and extracts relevant information from the document in order to populate the fields within the XML record. If the recently uploaded resume is identified as belonging to an existing candidate, the candidate's existing XML record is retrieved from the database 112 and is updated based on the information acquired by parsing the recently uploaded resume.

In step 810, illustrated in FIG. 8, the created/updated XML record is saved into the database 112 within the talent cloning system 100.

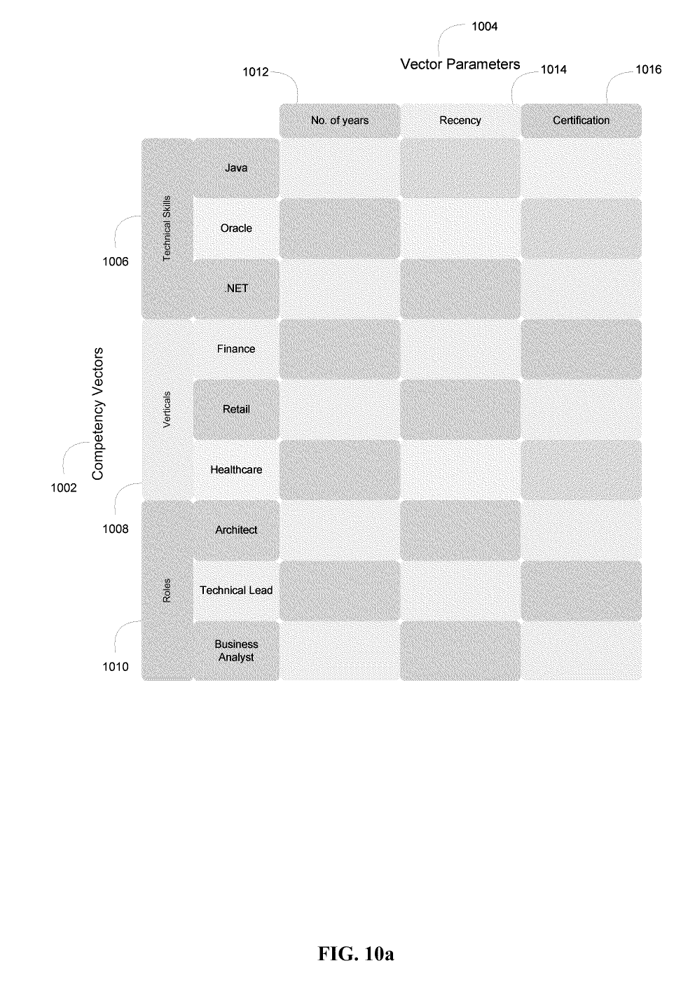

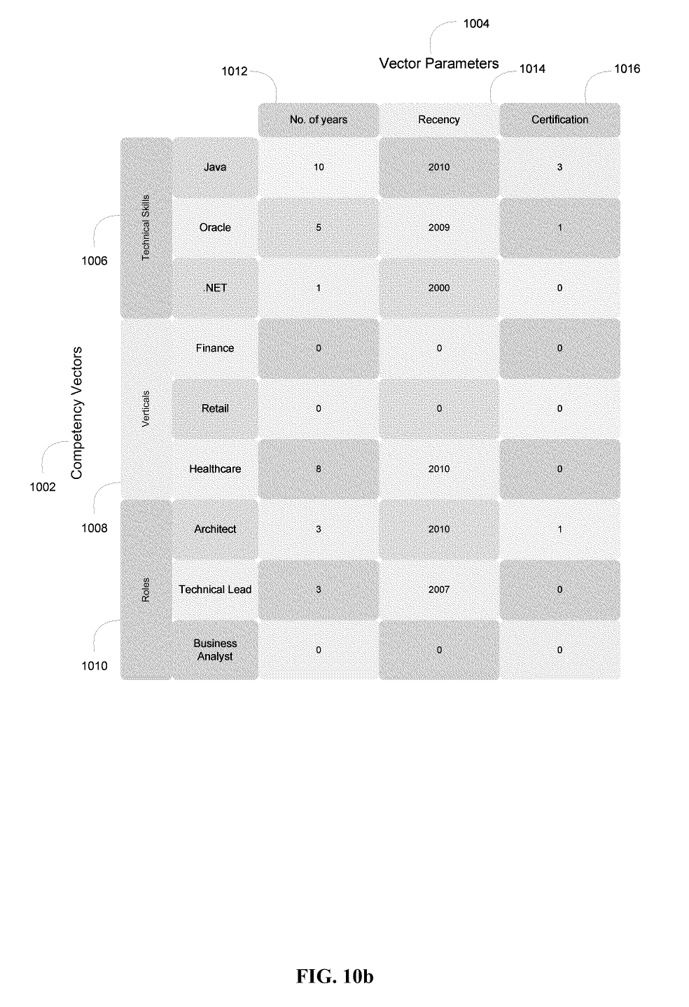

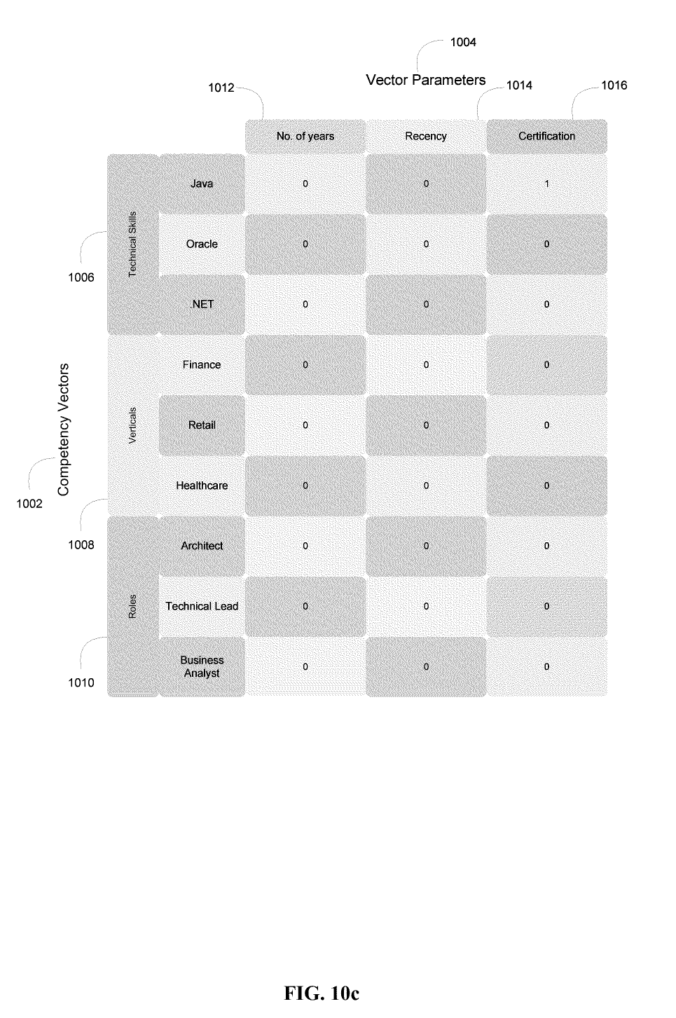

Referring to FIG. 8, in step 812, the profile image builder 334 constructs a profile image for the candidate using the candidate's XML record. Profile image is a two dimensional artifact constructed by the talent cloning system 100 that serves to encapsulate a holistic representation of the candidate's skills, experience and qualifications. FIG. 10a illustrates an exemplary profile image template. An embodiment of the profile image consists of several pre-defined competency vectors 1002, with each competency vector consisting of several vector parameters 1004. In the example illustrated in FIG. 10a, the competency vectors are categorized into the three broad areas of technical skills 1006, verticals 1008 and roles 1010, and include vectors representing Java, Oracle, .NET, Finance, Retail, Healthcare, Architect, Technical Lead and Business Analyst. The example illustrated in FIG. 10a, further includes vector parameters such as Number of years 1012, Recency 1014, and Certification 1016. Number of years 1012 refers to the total number of years of experience the candidate has with that skill, Recency 1014 refers to how recently the skill was put to use, and Certification 1016 refers to the number of certifications in that area. In alternate embodiments, the profile image template may be customized based on the context of use. The profile image builder 334 is a software program that scans the candidate's XML record, extracts relevant information from it and populates the fields within the profile image template. If the recently uploaded resume is identified as belonging to an existing candidate, the candidate's existing profile image is retrieved from the database 112 and is updated based on the information acquired by parsing the recently uploaded resume. FIG. 10b illustrates an exemplary profile image for a candidate.

Returning to FIG. 8, in step 814, the created/updated profile image is saved into the database 112 within the talent cloning system 100.

The talent cloning system's database 112 maintains a multidimensional profile space consisting of profile images, each of which occupies a point in the multidimensional space. Each axis of the multidimensional space is characterized by a ‘competency vector-vector parameter’ combination, with the total number of dimensions being equal to the total number of ‘competency vector-vector parameter’ combinations in the profile image template. Each profile image in the multidimensional space is therefore characterized by a point, the location of which is determined by the values contained within the profile image. FIG. 10c illustrates an exemplary profile image for a candidate, whose only qualification happens to be a certification in Java. In the multidimensional space, therefore, the profile image of this exemplary candidate will find a presence on the axis representing ‘Java-Certification’ since all other values within the profile image are zero. The multidimensional space is also characterized by clusters of resources that have similar profiles, since similar vector values directly implies similar location assignments. In step 816, illustrated in FIG. 8, the multidimensional profile space is updated by including the newly created/updated profile image in it.

Cloning Phase

Referring to step 420, illustrated in FIG. 4, when the user initiates the cloning process by clicking on the cloning button, the cloning engine 116 first identifies the profile image corresponding to the candidate of interest in the multidimensional profile image space. The cloning engine 116 then computes the Euclidean distances between the profile image of the candidate of interest and those corresponding to other candidates.

Let us assume that the ‘target’ resource has an image profile that is characterized in the system by a vector ‘t’

t=(t₁₁, t₁₂, t₁₃, . . . t₁ₘ, t₂₁, t₂₂, . . . tₙₘ,)

where n is the total number of competency vectors, m is the number of vector parameters, andt ‘t₁₁, t₁₂, t₁₃ . . . tₙₘ’ are the vector component values.

Let us assume a second profile image that is characterized by a vector ‘s’

s=(s₁₁, s₁₂, s₁₃, . . . s₁ₘ, s₂₁, s₂₂, . . . , sₙₘ)

where n is the total number of competency vectors, m is the number of vector parameters, and ‘s₁₁, s₁₂, s₁₃, . . . sₙₘ’ are the vector component values.

The Euclidean distance between profiles ‘t’ and ‘s’ is computed

$$d ( t , s ) = \sqrt{{\sum }_{i = 1}^{n} {\sum }_{j = 1}^{m} {( {t}_{ij} - {s}_{ij} )}^{2}}$$

The Euclidean distance between two profile images in the multidimensional profile space is directly indicative of how close their vector values are, and as a result, how similar the profiles they represent are. Therefore, the Euclidean distance between two profile images that fall within the same cluster will be far lesser than the Euclidean distance between images that belong to different clusters.

The distance computation above assumes equal weightage for all competency vectors and vector parameters. Referring to step 418 in FIG. 4, in an alternate embodiment, users will have the ability to prioritize one category of competency over another and similarly one parameter over another. Examples of situations where this embodiment will come of use include
While trying to identify candidates that are similar to a target candidate that is certified in a certain niche area of competency, the user might find the need to prioritize the ‘certification’ parameter over other parameters such as ‘recency’ of use
If the roles played by the candidate of interest presents a higher degree of relevance compared to other elements of the candidate's profile, the user will find the need to be able to prioritize the ‘role’ competency vectors over others
If the user would like the presence or absence of certification in profiles to have no bearing on the level of match, he would need to have the ability to direct the utility to ignore the corresponding parameter

In order to do this, the user clicks on the cloning advanced settings button 626 illustrated in FIG. 6, causing a cloning advanced settings screen to be displayed by means of a pop-up window. FIG. 7 illustrates an example of a cloning advanced settings screen. By default, the cloning advanced settings screen 700 will exhibit equal weightage across all parameters. The user may however adjust the weightage using the slider controls 702, prior to executing cloning.

In this case, the weighted Euclidean distance between profiles ‘t’ and ‘s’ is computed as

$$d ( t , s ) = \sqrt{( \{ {\sum }_{i = 1}^{m} {\sum }_{j = 1}^{n} [ ( \frac{{w}_{ij}}{{\sum }_{i} {\sum }_{j} w} ) \times {( {t}_{ij} - {s}_{ij} )}^{2} ] \} ) \times ( {\sum }_{i = 1}^{m} {\sum }_{j = 1}^{n} {w}_{ij} )}$$

where, n is the total number of competency vectors, m is the number of vector parameters, ‘t₁₁, t₁₂, t₁₃ . . . ’ are the vector component values, and wᵢⱼ is the weight corresponding to the specific ‘competency vector’-‘vector parameter’ combination as set by the user using the slider controls 702 in the cloning advanced settings window 700 illustrated in FIG. 7.

During computation of the weighted Euclidean distance between two profile images, in the event of absence of the recency parameter value in a certain competency vector within one of the profile images, while it is present in the other image, the value is set as the minimum (or maximum) of the corresponding recency parameter value amongst all profile images that are taken up for computation and scoring, based upon which of the two values (minimum or maximum) provides for the maximum distance. This helps set a reasonable boundary on the missing value, without compromising on other images that have this value present.

Search Results Display Phase

Following computation of Euclidean distances by the cloning engine 116 as described above, candidates whose profile images are closest to that of the target candidate's (in terms of Euclidean distance) are displayed on the search results display panel 610, illustrated in FIG. 6. Each such candidate is represented by means of a candidate object 612a, as illustrated in FIG. 6. In one embodiment, spheres labeled with the names of candidates are used as candidate objects. In alternate embodiments, any graphical shape/element may be used as candidate objects. In one embodiment, a gradient background is used on the search results display panel 610, and candidate objects are positioned on the gradient display based on the Euclidean distance values with those with the shortest Euclidean distance from the target candidate being placed closer towards the center. The distance of a candidate object from the center of the display is a direct visual indicator of the level of match of the represented candidate with the target candidate. In another embodiment, candidate objects representing similar candidates are clustered together on the search results display panel 610. The level of similarity between two matching candidates to be displayed on the search results display panel 610 is derived by the distance between the profile images representing the two candidates in the multidimensional profile space. Since candidates with similar profiles tend to have similar profile images and hence be within close proximity in the multidimensional profile space, the candidate objects representing them on the search results display panel 610 will be clustered together.

Referring to FIG. 6, a summary of the search results is displayed in the search summary display panel 616. The information displayed in the search summary display panel 616 includes ‘number of candidates searched’, and ‘number of candidates that are returned as results by the cloning engine’.

Further in reference to FIG. 6, when the user places the mouse pointer over a candidate object 612c in the search results display panel 610, a profile snapshot window 614 pops open. Information pertaining to the candidate displayed on the profile snapshot window 614 is procured by the talent cloning system 100 from the candidate information system 108.

When the user clicks on a candidate object 612a, information pertaining to the candidate represented by the candidate object 612a gets displayed on the candidate profile display panel 618, candidate synopsis/skills display panel 620, and the candidate score/report display panel 622. In one embodiment, the candidate profile display panel 618 includes information such as candidate's name, location, contact details, video profile, availability status, and links to external websites that carry more information about the candidate. Alternate embodiments will offer the ability to customize the information displayed in this panel. Information pertaining to the candidate displayed on the candidate profile display panel 618 is procured by the talent cloning system 100 from the candidate information system 108.

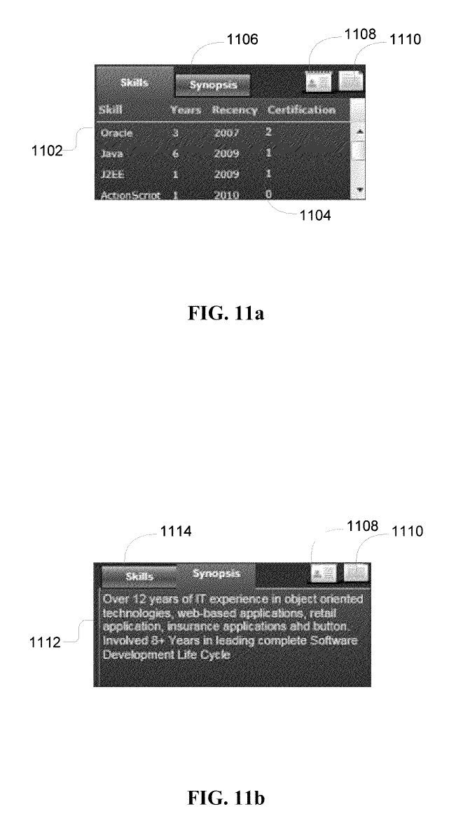

FIGS. 11a and 11b illustrate exemplary views of the synopsis/skills display panel 620. In one embodiment, the default view is as illustrated in FIG. 11a, where the user is displayed a skills matrix 1102 consisting of the number of years of experience, recency and number of certifications for each of the skills in the search criteria. When the user places the mouse pointer over an item representing the number of certifications 1104, a window pops open listing details about the certification(s). In one embodiment, this includes details such as certification name, name of the certifying agency, and date until which the certification is valid. When the user clicks on the synopsis button 1106, the synopsis/skills display panel 620 toggles view as shown in FIG. 11b to display the candidate's professional summary 1112. The user may toggle back to the skills view by clicking on the skills button 1114 illustrated in FIG. 11b.

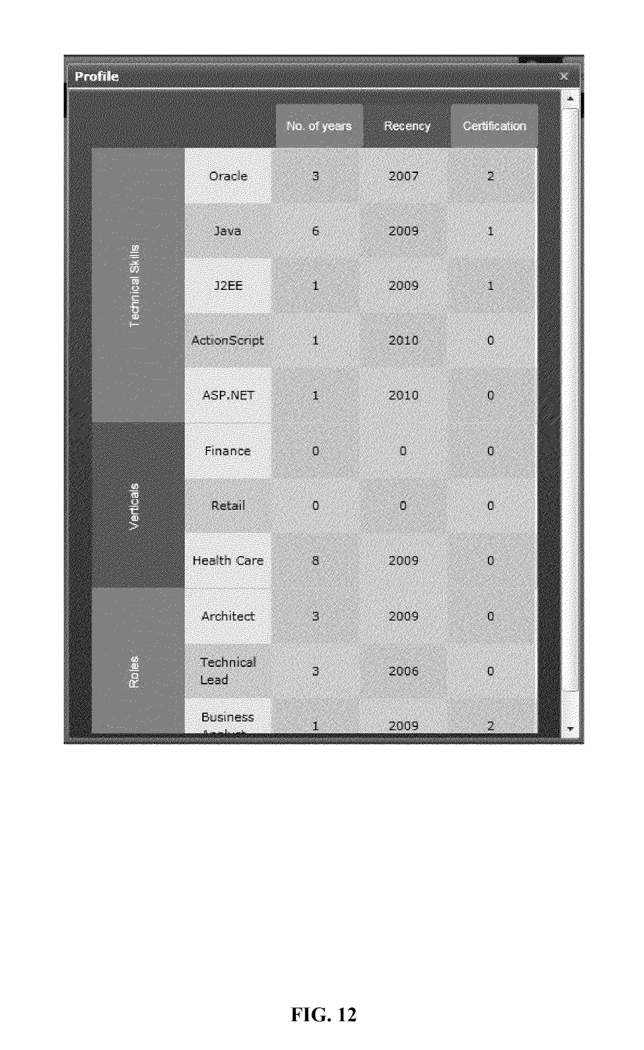

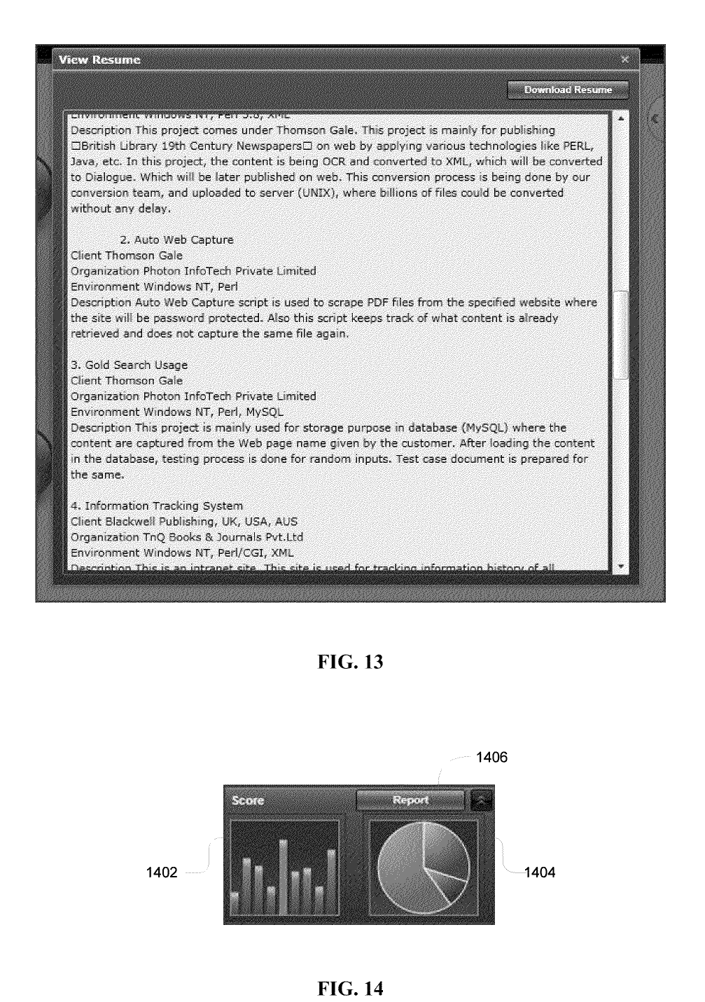

When the user clicks on the profile image button 1108, a profile image display window opens up to display the profile image of the selected candidate. FIG. 12 illustrates an exemplary profile image display window. When the user clicks on the resume button 1110, a resume display window opens up to display the candidate's resume. FIG. 13 illustrates an exemplary resume display window. An embodiment of the resume display window also enables the user to download the resume in a variety of formats.

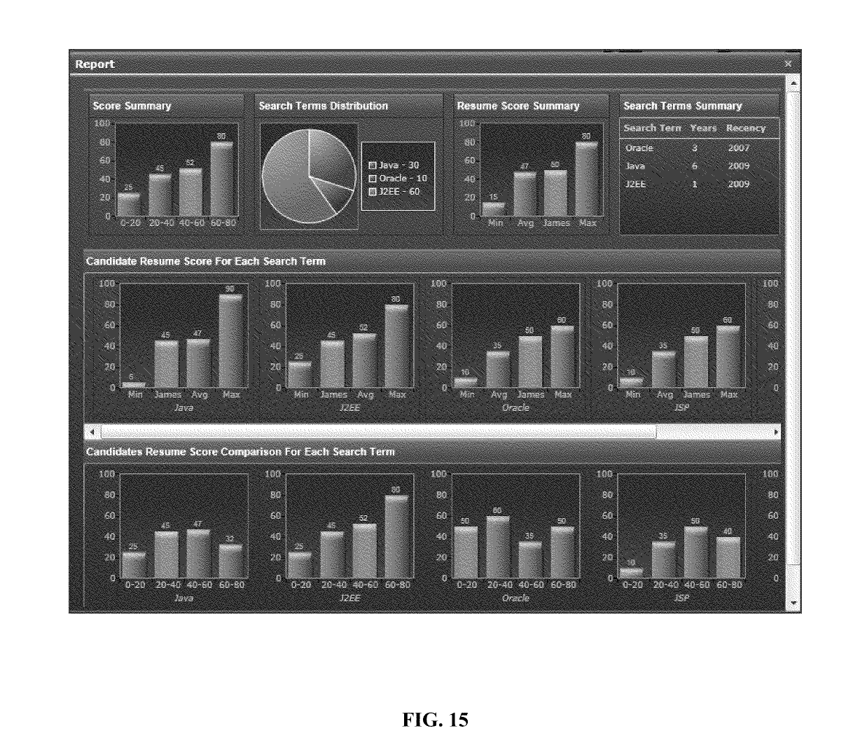

FIG. 14 illustrates a closer view of the score/report display panel 622. In one embodiment the score/report display panel includes a histogram 1402 that shows the selected candidate's level of match with the target candidate amongst those of other matching candidates, and a pie-chart 1404 showing distribution of scores amongst the skills of the selected candidate. The level of match is a function of the Euclidean distance between the profile image of the selected candidate and that of the target candidate. When the user clicks on the report button 1406 in the score/report display panel 622 illustrated in FIG. 14, a report display window opens up. FIG. 15 illustrates an exemplary report display window.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is intended that they be deemed within the scope of this invention.

We claim:

1. A method for identifying at least one candidate from a plurality of candidates based on at least one target candidate profile associated with the at least one target candidate, the method comprising:
constructing profile images for candidates;
representing the at least one candidate profile in a multi-dimensional characteristic space;
executing a search of a plurality of candidate profiles associated with the plurality of candidates; and
identifying the at least one candidate having the at least one candidate profile almost identical to the at least one target candidate profile.

2. The method of claim 1, further comprising acquiring a resume and monitoring the arrival of new resume files into a candidate information system/resume repository by a multisource talent acquisition system and the subsequent processing of the resume files.

3. The method of claim 1, further comprising assigning varying weightage to different parameters of the target candidate's profile, and prioritizing one category of competency over another and one parameter over another.

4. The method of claim 1, further comprising performing a contextual information search on candidate resumes, evaluating the context of occurrence of each search term on the candidate's resume in order to efficiently value real-world project experience, efficiently value recent project experiences, and identifying and valuing possible certifications and specialist level skills.

5. The method of claim 1, wherein candidates are positioned on a gradient display based on the distance values with those with the shortest distance from the target candidate being placed closer towards the center, wherein the distance of a candidate object from the center of the display is a direct visual indicator of the level of match of the represented candidate with the target candidate.

6. A method for identifying at least one candidate from a plurality of candidates based on at least one target candidate profile associated with the at least one target candidate, the method comprising:
constructing profile images for candidates;
representing the at least one candidate profile in a multi-dimensional characteristic space;
executing a search of a plurality of candidate profiles associated with the plurality of candidates; and
identifying the at least one candidate having the at least one candidate profile almost identical to the at least one target candidate profile, wherein the candidate profile is constructed using the candididates resume and an XML record.

7. The method of claim 6, wherein the profile image is a multi-dimensional artifact that encapsulates a holistic representation of at least one of the at least one candidate's skills, the at least one candidate's experience and the at least one candidate's qualifications.

8. The method of claim 7, wherein the profile image comprises at least one pre-defined competency vector.

9. The method of claim 6, further comprising a multidimensional profile space consisting of at least one profile image, wherein the at least one profile image occupies a point in a multidimensional profile space.

10. The method of claim 9, wherein each axis of the multidimensional profile space is characterized by a competency vector-vector parameter combination, wherein a total number of competency vector-vector parameter combinations is equal to a total number of dimensions.

11. The method of claim 9, wherein identifying the at least one candidate having the at least one candidate profile almost identical to that of at least one target candidate comprises determining distances between a plurality of candidate profile images and the at least one target candidate profile image in the multidimensional profile space.

12. The method of claim 11, wherein identifying the at least one candidate having the at least one candidate profile almost identical to that of at least one target candidate further comprises determining the at least one profile image of the plurality of profile images having a smallest distance with respect to the at least one target candidate profile image.

13. The method of claim 11, wherein candidate profiles having similar profile images will be located in close proximity in the multidimensional profile space.

14. A system for automatically identifying at least one candidate from a plurality of candidates based on at least one target candidate profile associated with the at least one target candidate, the system comprising:
a memory for storing instructions and data, the data comprising a set of programs and a dataset having one or more data fields;
a processor executing the instructions and processing the data, wherein the instructions comprise:
constructing profile images for candidates;
representing the at least one candidate profile in a multi-dimensional characteristic space;
executing a search of a plurality of candidate profiles associated with the plurality of candidates; and
identifying the at least one candidate having the at least one candidate profile almost identical to the at least one target candidate profile.

15. The system of claim 14, wherein the at least one candidate profile image is constructed using the candidate's resume and XML record, where the profile image is a multidimensional artifact that encapsulates a holistic representation of at least one of the at least one candidate's skills, the at least one candidate's experience and the at least one candidate's qualifications.

16. The system of claim 14, further comprising a multidimensional profile space consisting of a plurality of profile images, wherein each of the profile images occupies a point in multidimensional profile space.

17. The system of claim 16, wherein each axis of the multidimensional profile space is characterized by a competency vector-vector parameter combination, wherein a total number of competency vector-vector parameter combinations being equal to a total number of dimensions

18. The system of claim 14, wherein identifying the at least one candidate having the at least one candidate profile image almost identical to that of at least one target candidate comprises determining distances between a plurality of candidate profile images and the at least one target candidate profile image.

19. The system of claim 14, wherein identifying the at least one candidate having the at least one candidate profile image almost identical to that of at least one target candidate further comprises determining the at least one profile image of the plurality of profile images having a smallest distance with respect to the at least one target candidate profile image.
